(19) United States
(12) Patent Application Publication
(10) Pub. No.: US 2025/0194711 A1
(43) Pub. Date: Jun. 19, 2025

(54) FLEXIBLE CONDUCTIVE POLYMER FOR GRAFTING TO POLYMERIC SURFACES

(71) Applicant: David Ronald Crotzer, Nashua, NH (US)

(72) Inventor: David Ronald Crotzer, Nashua, NH (US)

(21) Appl. No.: 18/982,164

(22) Filed: Dec. 16, 2024

Related U.S. Application Data
(60) Provisional application No. 63/629,924, filed on Dec. 15, 2023.

(51) Int. Cl. A41D 13/012; B63C 11/04; B64G 6/00

(52) U.S. Cl. CPC A41D 13/012; B63C 11/04; B64G 6/00

(57) ABSTRACT

The present invention is directed towards a flexible conductive polymer for grafting to polymeric surfaces. The grafted polymeric devices expand and move with the space and/or diving suit fabric, hence, the devices on the suit fabric moves together. Supplying additional air in the closed loop system extends the utility of working in unique environments.

### CROSS-REFERENCE TO RELATED APPLICATION

This application claims the benefit of priority of U.S. provisional application No. 63/629,924, filed Dec. 15, 2023, the contents of which are herein incorporated by reference.

### BACKGROUND OF THE INVENTION

Bulky deep-sea diving suits and space exploration suits, which are designed to protect users in extreme environments, face several significant challenges:

Mobility Limitations: These suits are large and heavy, making it difficult for users to move freely. The stiff, cumbersome design can restrict their ability to perform intricate tasks, such as handling equipment or rescuing others.

Weight and Buoyancy: Deep-sea suits are typically heavy, requiring divers to wear additional ballast or weights to counteract the buoyancy of the suit. This can add to the physical strain on the diver, especially during ascent or long-duration dives.

Complexity of Use: The suits often have complicated systems for air supply, communication, and temperature regulation. This complexity can be difficult to manage, especially under stressful conditions or in emergencies, increasing the risk of malfunction or accidents.

Limited Dexterity: The thick, reinforced material that protects users from extreme pressures and temperatures reduces their ability to perform tasks with fine motor control. This can make performing delicate operations, such as repairing equipment or manipulating small objects, challenging.

Thermal Regulation Issues: Maintaining a stable temperature inside the suit can be problematic. Overheating or extreme cold can cause discomfort or even health issues if the suit's thermal regulation system fails.

Pressure Effects: External pressure can make the suit compress and become even more restrictive. The weight of the suit increases with depth, and the diver's body also has to endure the effects of increased pressure, which can lead to discomfort or physical strain.

Communication Difficulties: Communication systems within the suits, such as voice systems, are often prone to malfunction due to environmental factors. This can make it difficult for the user to stay in touch with other personnel or other team members, especially during high-stress situations.

Maintenance and Repair: Deep-sea and outer space suits are highly specialized, making them expensive to maintain and repair. Any malfunction requires expert knowledge, and repairing the suit is difficult, especially in remote or hazardous environments.

Cost and Accessibility: The technology behind such suits is costly, which limits their availability.

Health Risks: Extended use of these suits can lead to a variety of health issues, including fatigue, dehydration, and muscle strain due to the suit's weight and design. Moreover, the prolonged pressure at great depths can cause decompression sickness if the diver does not ascend slowly and properly.

Limited Duration: Current suits used for diving and space exploration can only function for a limited period of time based on available air in tanks on the back of the suits.

Current suit designs are extremely bulky with the size of the attached systems which introduce constraints (swimming, bending, dressing, etc.) when working in each unique environment.

Overall, while such suits are essential for safety in extreme conditions, they present numerous operational and physical challenges for users. The present invention is directed at overcoming shortcomings with conventional suit designs.

### SUMMARY OF THE INVENTION

In one aspect of the present invention, there is disclosed a device capable of conducting an electrical current on a flexible polymeric surface, providing an attachment of a flexible battery to that surface, providing a conductive path to a plethora of lights on the same surface, and an attachment of flexible solar arrays connected to said surface.

The grafted polymeric device expands and moves with the space and/or diving suit fabric, hence, the devices on the suit fabric moves together. Supplying additional air in the closed loop system extends the utility of working in unique environments

These and other features, aspects and advantages of the present invention will become better understood with reference to the following drawings, description and claims.

### BRIEF DESCRIPTION OF THE DRAWINGS

FIG. 1 is a front perspective view of a flexible conducive polymer for grafting to polymeric surfaces in accordance with a preferred embodiment of the present invention;

FIG. 2 is a rear perspective view of a flexible conducive polymer for grafting to polymeric surfaces in accordance with a preferred embodiment of the present invention; and

FIG. 3 is a front perspective view of a flexible conducive polymer for grafting to polymeric surfaces in accordance with an alternative preferred embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device capable of conducting an electrical current on a flexible polymeric surface, providing an attachment of a flexible battery to that surface, providing a conductive path to a plethora of lights on the same surface, and an attachment of flexible solar arrays connected to said surface.

The device can be produced of a chemically grafted conductive polymeric structure which is bonded polymer chain to chain. The conductive paths are similar to circuit board traces which can exhibit elastomeric to rigid conditions dependent on its construct and type of surface bonded.

Methods for circuit deposition include thick film emulsion, stencil, spray, and transfer print, to name a few. Attachment of the devices to the material surfaces can be accomplished by grafting of each device to the material surface targeted.

Devices and systems constructed in accordance with preferred embodiments of the present invention has numerous uses and applications, including, but not limited to, the following:
1. An electrical current on a flexible polymeric surface.
   a. A plethora of conductive traces on various material surfaces forming circuits.
2. An attachment of a flexible battery to that surface.
   a. A flexible conductive polymeric battery cell can become part of a rubber (elastomeric) surface.
3. A conductive path to a plethora of lights on the same surface.
   a. Polymeric lights can be attached to a rubber (elastomeric) surface to illuminate areas involving a fireman (jacket and boots) or a diver (wet suit).
4. An attachment of flexible solar arrays connected to said surface.
   a. Flexible solar arrays can be attached to materials used in space to provide a charge to the battery and illumination around an astronaut to assist in performing work outside in vacuum conditions.
5. A flexible configuration connected to a surface for converting carbon dioxide into oxygen.
   a. A configuration of a polymeric membrane absorbing carbon dioxide and passing through a plethora of lights connected to a polymeric battery producing oxygen within the suit as the astronaut moves.

Current suits used for diving and space exploration can only function for a limited period of time based on available air in tanks on the back of the suits. The invention claimed here solves this and other problems with conventional devices and systems.

The invention has polymeric devices as part of the suit which includes a flexible polymeric CO2 Converter which provides C and O2 in the suit. The C ism collected by passing C molecules through a Hollow Fiber Filter. The O2 molecules are passed through the filter into the breathing unit in the suit.

The claimed invention differs from what currently exists. The flexible polymeric devices on the suits are lighter and more efficient on the suits. The flexible Solar Arrays grafted to the back of the space suit supplies power to the battery. The battery provides power for the LEDs on the sleeves and in the front of the suits. In addition, the battery provides power to the Bio-converter system recycling the organic waste into usable water from the individual's urine accumulating in the suit.

The present invention provides many benefits over conventional systems and devices, including:
1. Unique situations with flexibility during bending or stretching in the space suit.
2. Restricted breathing times in each type of suit.
3. Total suit weight reduced by 35-50%.

The grafted polymeric devices expands and moves with the space and/or diving suit fabric, hence, the devices on the suit fabric moves together. Supplying additional air in the closed loop system extends the utility of working in unique environments.

Also, it can produce
1. Flexible polymeric batteries.
2. Grafting materials for attachment to two flexible surfaces.
3. Flexible Solar and LED Arrays that are deposited as 1.0 mm arrays from 16×16 to 50×50 individual contacts per array.

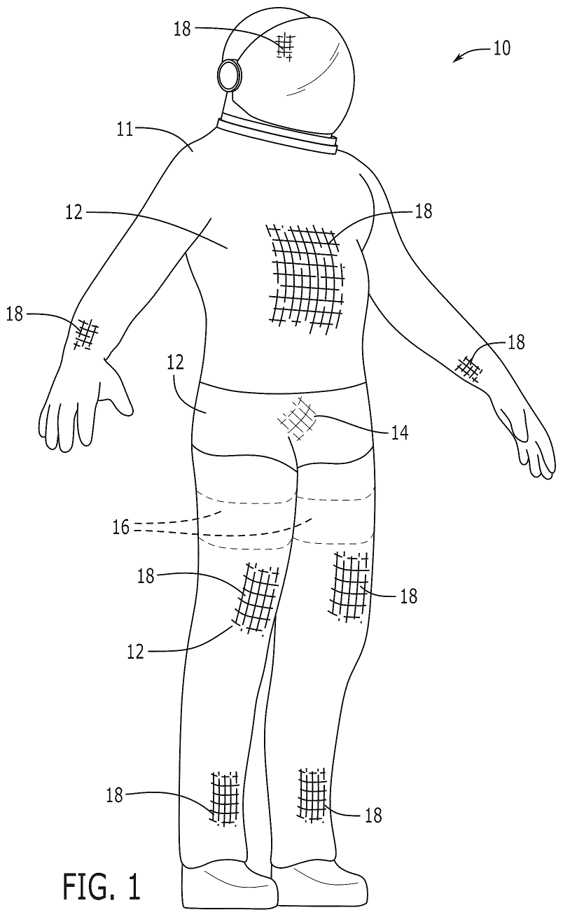

As discussed herein, and as seen in FIGS. 1-3 hereto, in preferred embodiments the present invention comprises the following primary components:

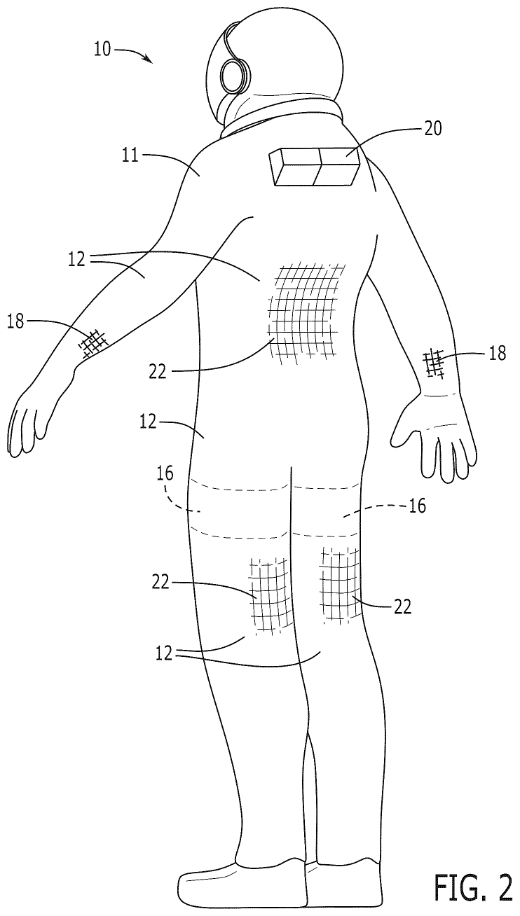

FIGS. 1 and 2 depict front and rear perspective views of a flexible conducive polymer for grafting to polymeric surfaces in accordance with a preferred embodiment of the present invention. As seen in FIG. 1, the flexible conductive polymer 10 forms a space suit 11 having multiple flexible polymeric devices 12 incorporated into suit 11. Suit 11 also comprises a urine to water converter 14, flexible elastic batteries 16 and multiple flexible polymeric LED arrays 18. Suit 11 also comprises a CO2 converter 20 together with multiple flexible polymeric solar arrays 22.

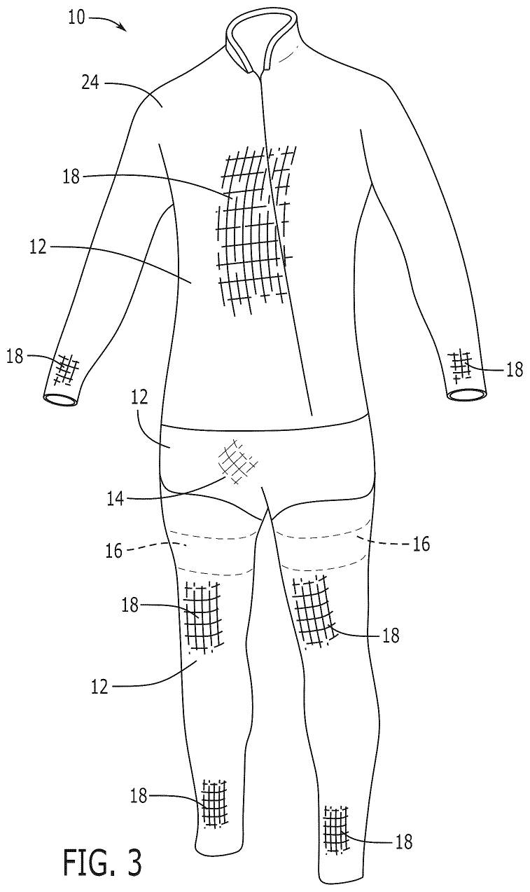

FIG. 3 depicts a front perspective view of a flexible conducive polymer for grafting to polymeric surfaces in accordance with an alternative embodiment of the present invention. Similar to the embodiment shown in FIGS. 1 and 2, the alternative embodiment of FIG. 3 comprises a flexible conductive polymer 10 forming a space suit 24 having multiple flexible polymeric devices 12 incorporated into suit 24. Suit 24 also comprises a urine to water converter 14, flexible elastic batteries 16 and flexible polymeric LED arrays 18. Suit 24 also comprises a CO2 converter 20 (not shown) together with multiple flexible polymeric solar arrays 22 (not shown).

The solar cell arrays 22 on the outside of the space suit provides power to charge the polymer batteries 16 on the inside of the suit. The batteries provide power in the suit for the CO2 converter 20, the urine to water converter 14, and switches, the batteries provide power to the outside of the suit for the LED Arrays 18.

The flexible batteries are necessary to maintain the power to the systems in order to extend the operational time in the suits. The LED Arrays 18, and a bio-converter can be optional. The CO2 and urine converters can be relocated on the suits and still maintain the basic functions.

A user can place the flexible solar arrays under a bank of solar lights and charge/power the batteries connected to the systems. This can provide O2 to other applications such as oxygen tents in a hospital.

Additionally: The invention can be used to provide O2 to other environments that need O2 such as HVAC in an apartment to minimize CO2.

Also, it can create flexible polymeric batteries; grafting materials for attachment to two flexible surfaces; flexible solar and LED arrays that are deposited as 1.0 mm arrays from 16×16 to 50×50 individual contacts per array.

It should be understood, of course, that the foregoing relates to exemplary embodiments of the invention and that modifications may be made without departing from the spirit and scope of the invention as set forth in the following claims.

What is claimed is:

1. A suit formed of a flexible conducive polymer for grafting to polymeric surfaces, the suit having multiple flexible polymeric devices incorporated thereon.

2. The suit of claim 1, further comprising a urine to water converter.

3. The suit of claim 1, further comprising a flexible elastic battery.

4. The suit of claim 1, further comprising a flexible polymeric LED array.

5. The suit of claim 1, further comprising a CO2 converter.

6. The suit of claim 1, further comprising a polymeric solar array.

7. The suit of claim 6, wherein the suit is designed and constructed to be worn by a user for deep sea diving.

8. The suit of claim 6, wherein the suit is designed and constructed to be worn by a user in outer space.
